(19) United States
(12) Patent Application Publication
(10) Pub. No.: US 2011/0220568 A1
(43) Pub. Date: Sep. 15, 2011

(54) PORTABLE FILTER ASSEMBLIES

(75) Inventor: John C. Ruprecht, North Oaks, MN (US)

(73) Assignee: CLEAN & CLEAR CORPORATION, White Bear Lake, MN (US)

(21) Appl. No.: 12/723,109

(22) Filed: Mar. 12, 2010

(51) Int. Cl. B01D 35/30; B23P 19/04

(52) U.S. Cl. 210/238; 29/700

(57) ABSTRACT

A portable housing contains and forms a space around a filter element to form a portable filter assembly that can provide filtered hydration from a portable fluid reservoir. The housing includes an inlet port, which is in fluid communication with the space, and an outlet port, which is in fluid communication with a core of the filter element, wherein an external fitting of the housing, which is configured for coupling to a suction source outside the housing, surrounds the outlet port. The suction force draws fluid into the space, from the reservoir, which may be coupled to the inlet port by a tubular member, and then through the filter element and out the outlet port. An attachment feature may extend from an outer surface of the housing so that a strap-like member may engage therewith.

### TECHNICAL FIELD

The present invention pertains to fluid filtration and more particularly to portable filter assemblies an associated methods.

### BACKGROUND

Numerous types of relatively small and portable containers are available for carrying fluids, for example, drinking water. Some of these include built-in filtration systems, but many do not. Thus, there is a need for new portable filter assemblies and associated methods of providing filtered hydration from portable fluid reservoirs.

### BRIEF DESCRIPTION OF THE DRAWINGS

The following drawings are illustrative of particular embodiments and methods of the present disclosure and, therefore, do not limit the scope of the invention. The drawings are not to scale (unless so stated) and are intended for use in conjunction with the explanations in the following detailed description. Embodiments and methods will hereinafter be described in conjunction with the appended drawings, wherein like numerals denote like elements.

FIG. 1A is a plan view of a portable filter assembly, according to some embodiments of the present invention.

FIGS. 1B-C are section views through the filter assembly shown in FIG. 1A, according to some embodiments.

FIG. 2 is an exploded perspective view of a housing of the filter assembly, according to some embodiments.

FIG. 3 is a plan view of the filter assembly of FIG. 1A coupled to a portable fluid reservoir, according to some embodiments and methods of the present invention.

FIG. 4A is a plan view of a filter assembly coupled to another portable fluid reservoir, according to some alternate embodiments of the present invention.

FIG. 4B is a plan view of a portion of a housing of a filter assembly, according to yet further embodiments.

### DETAILED DESCRIPTION

The following detailed description is exemplary in nature and is not intended to limit the scope, applicability, or configuration of the invention in any way. Rather, the following description provides practical illustrations for implementing exemplary methods and embodiments. Examples of constructions, materials and dimensions are provided for selected elements, and all other elements employ that which is known to those of skill in the field of the invention. Those skilled in the art will recognize that many of the examples provided have suitable alternatives that can be utilized.

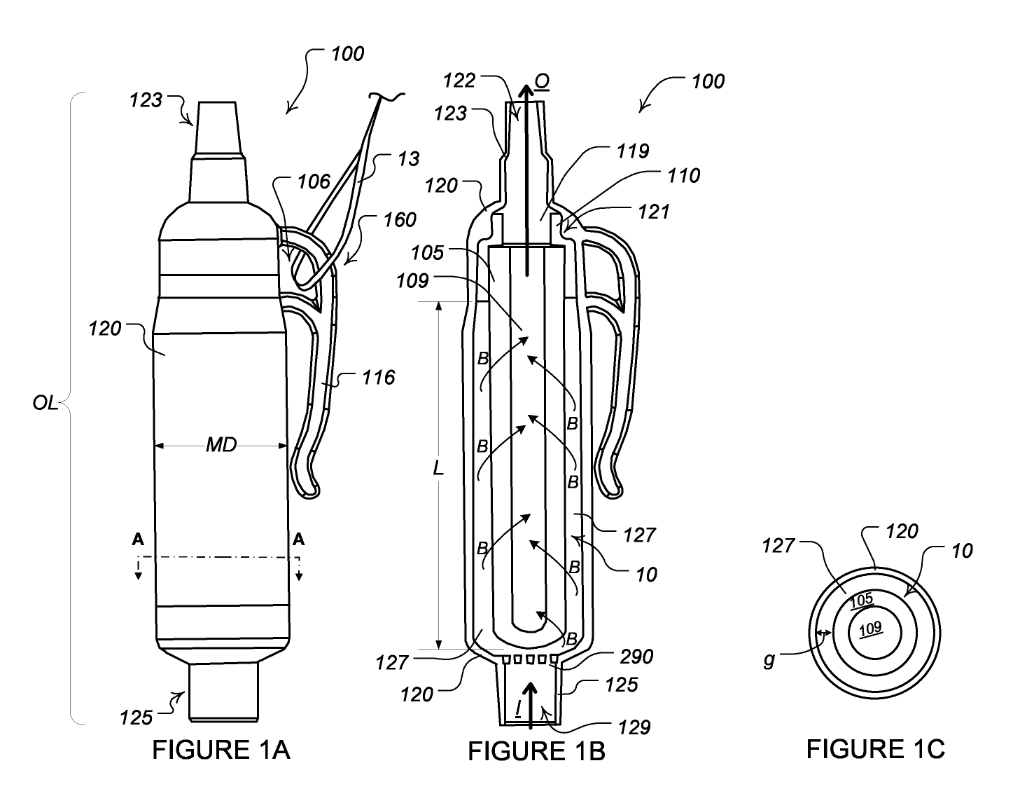

FIG. 1A is a plan view of a portable filter assembly 100, according to some embodiments of the present invention; and FIG. 1B is an axial section view through filter assembly 100, according to some embodiments. FIGS. 1A-B illustrate filter assembly 100 including a filter element 10 and a housing 120, which forms a space 127, surrounding filter element 10, and which contains space 127 and filter element 10. FIGS. 1A-B further illustrate housing 120 including an inlet port 129, an outlet port 122 and an internal fitting 121, which is coupled to an end cap 110 of filter element 10 such that a channel 119 of end cap 110 is approximately aligned with outlet port 122. End cap 110 may form a press-fit within fitting 121 and may or may not be secured thereto by some kind of bonding. An O-ring seal may be employed at the interface between end cap 110 and fitting 121. According to the illustrated embodiment, filter element 10 includes a porous ceramic sidewall 105 that surrounds a filtering media core 109, which is in fluid communication with channel 119 of end cap 110. According to some preferred embodiments, core 109 is formed by an activated carbon, for example, a granular activated carbon, and porous ceramic sidewall 105 is formed, for example, by casting, to include an internal space, which is filled with the activated carbon. A self-sanitizing agent that prevents bacterial growth, for example, approximately 0.05% silver, may be embedded in ceramic sidewall 105, and the porosity of sidewall 105 may provide up to 99.99% filtering efficiency at approximately 0.7 microns.

With further reference to FIG. 1B, housing 120 includes an external fitting 123 that surrounds outlet port 122 and is configured for coupling to a suction source, preferably, a mouth of a user, in order to draw a fluid through filter element 10. According to FIG. 1B, a suction force applied at external fitting 123 draws the fluid, per arrow I, through inlet port 129 and into space 127, and then through porous sidewall 105 to core 109, for example, per arrows B, and then out through outlet port 122, per arrow O. According to some embodiments, wherein core 109 is formed by granular activated carbon, a separate filter may be positioned within channel 119 in order to prevent particles of the carbon from flowing out with the fluid that flows out through outlet port 122. The mouth of the user of assembly 100 may apply the suction force directly to external fitting 123, or a tubular member may be attached to fitting 123 so that the suction force is applied through a lumen of the tubular member. It should be noted that space 127 is essentially empty before any fluid flows into housing 120 through inlet port 129.

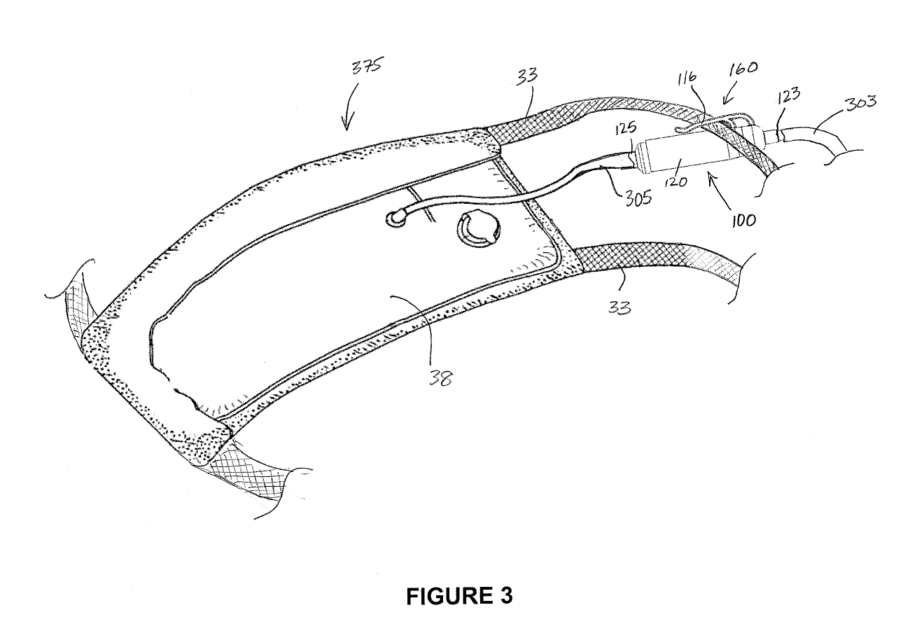

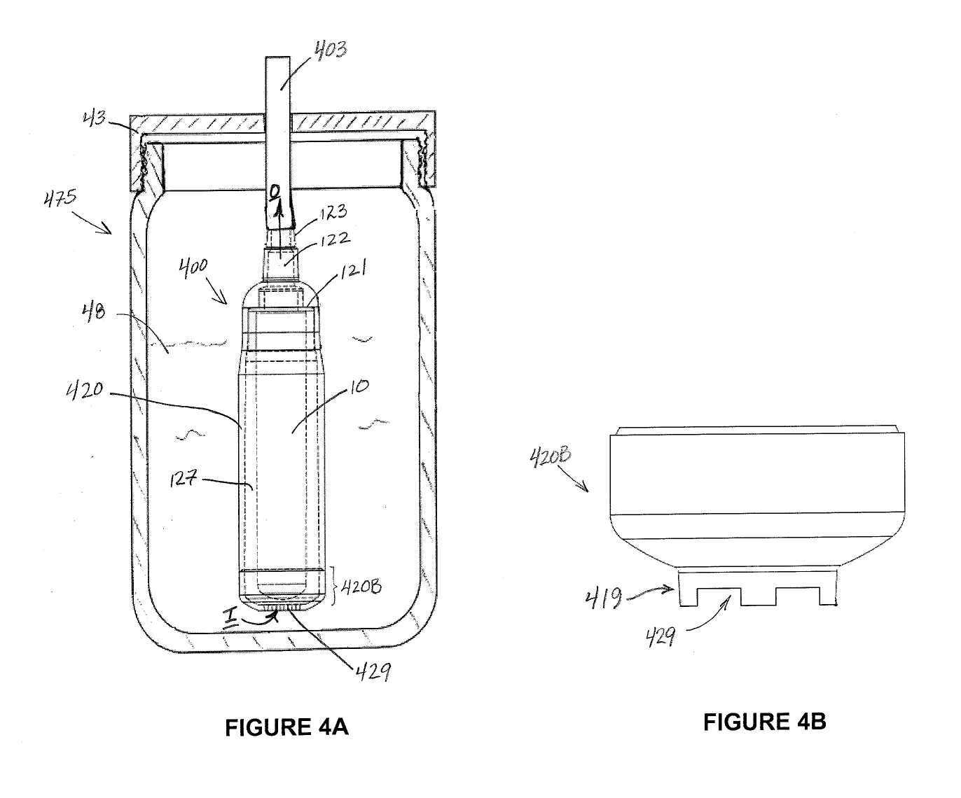

Inlet port 129 may be immersed in a fluid reservoir from which the fluid is drawn, for example, as described below, in conjunction with FIG. 4. Alternately, with further reference to FIGS. 1A-B, housing 120 preferably includes an optional external fitting 125, which surrounds inlet port 129 ands is configured for coupling to a tubular member whose lumen is in fluid communication with a fluid reservoir that is remote from filter assembly 100, for example, as described below, in conjunction with FIG. 3. In either case, a construction and relatively small size of filter assembly 100 makes assembly 100 portable for personal hydration purposes. According to an exemplary embodiment, an overall length OL of assembly 100 is approximately 5 inches and a maximum diameter MD is approximately 1 inch. Housing 120 is non-deformable under normal operating pressures of assembly 100, which are applied by the suction source, and is preferably wholly formed, for example, by a molding process, from a relatively rigid and inexpensive plastic material, for example, ABS (Acrylonitrile butadiene styrene) and/or polypropylene. With reference to FIG. 1C, which is a radial section view of filter assembly 100, taken through line A-A of FIG. 1A, space 127 comprises an annular section that is formed by a gap g between an outer surface of filter element 10 and an inner surface of housing 120. According to some preferred embodiments of the present invention, for example, in order prevent the amount of suction that the user needs to apply (in order to effectively draw the fluid into space 127 and through filter element 10) from being too excessive, gap g is minimized. According to an exemplary embodiment, gap g is no greater than approximately 0.2 inch and extends over a length L of filter element 10 (FIG. 1B), which has an outer diameter of approximately 0.55 inch; length L may be between approximately 2.5 inches and approximately 3 inches. It should be noted that gap g need not have a uniform dimension about an entire perimeter of filter element 10. Furthermore, a size of inlet port 129 may be maximized to reduce the amount of suction necessary to effective draw the fluid through filter assembly 100, and, according to an exemplary embodiment, a diameter of inlet port 129 is between approximately 0.4 inch and approximately 0.45 inch.

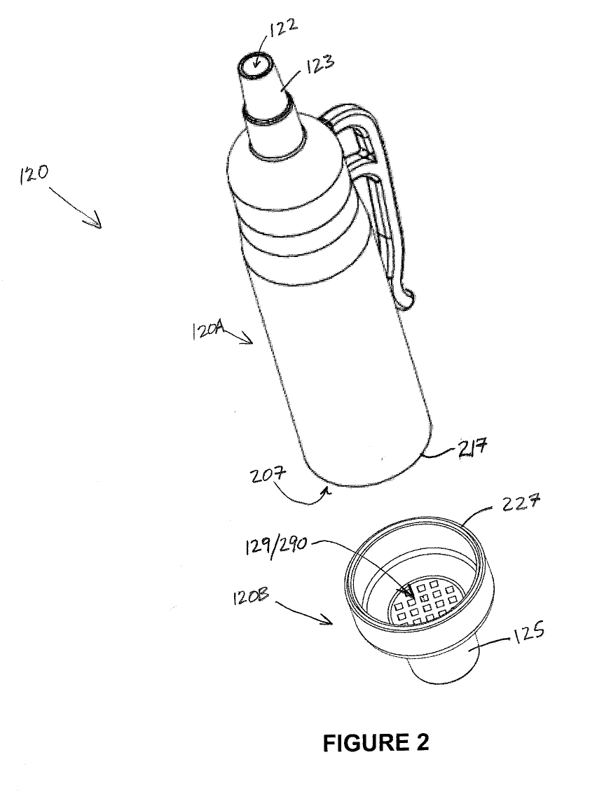

With further reference to FIG. 1B, inlet port 129 is shown including a plurality of apertures 290 formed through a sidewall of housing 120; apertures 290 may be better seen in FIG. 2. Apertures 290 form a grate to filter relatively large particles from the fluid flowing in through inlet port 129. According to an exemplary embodiment, in which the diameter of inlet port 129 is between approximately 0.4 inch and approximately 0.45 inch, the number of apertures 290 is between nine and twenty-one, and each has an area of between approximately 0.16 square inch and approximately 0.25 square inch.

FIG. 2 is an exploded perspective view of housing 120, according to some embodiments of the present invention wherein two parts 120A, 120B form housing 120. FIG. 2 illustrates a perimeter edge 217 of first part 120A and a mating perimeter edge 227 of second part 120B, which may be joined together by bonding and/or welding, according to methods known to those skilled in the art. According to some embodiments, parts 120A, 120B are sonically welded together, once filter element 10 has been fixed within first part 120A, for example, by coupling end cap 110 to internal fitting 121 (FIG. 1B), and filter assembly 100 is wholly disposable when filter element 10 is ‘spent’. According to some alternate embodiments, parts 120A, 120B may be reversibly attached to one another, for example, via a threaded and/or snap fit interface at perimeter edges 217, 227, so that a spent filter element can be replaced with a new filter element by separating parts 120A, 120B. Upon separation of parts 120A, 120B, the spent filter element can be accessed, through an opening 207 of first part 120A, removed from first part 120A and replaced with the new filter element, prior to re-attaching parts 120A, 120B to one another.

According to some preferred methods of the present invention, filtered hydration is provided from a portable fluid reservoir by coupling a portable filter assembly, for example, filter assembly 100, to a tubing member that extends from the portable reservoir. For example, FIG. 3 is a plan view of filter assembly 100 coupled to a portable fluid reservoir 38, which is part of a fluid bladder back pack 375. A portion of the back pack is cut away so that reservoir 38 may be seen. According to FIG. 3, a first end of a tubular member 305 has been coupled to reservoir 38 and a second end of tubular member 305 has been coupled to external fitting 125 of housing 120, so that a lumen of tubular member 305 is in fluid communication with reservoir 38 and with space 127 of assembly 100 (FIG. 1B). Thus, the one who wears backpack 375, by applying a suction force to external fitting 123, can draw the fluid into space 127, then through filter element 10 and out outlet port 122 (FIG. 1B), in order to receive filtered hydration from reservoir 38. Although FIG. 3 illustrates another tubing member 303 having been attached to external fitting 123, for example, to reach over a shoulder and to a mouth of the backpack-wearer, it should be appreciated that, alternately, tubing member 305 may be long enough to extend over the shoulder, so that the backpack-wearer can access filter assembly 100 for applying the suction force directly to fitting 123 without tubing member 303. With reference back to FIGS. 1A-B, external fittings 125 and 123 are each shown including a tapered section, which can facilitate the coupling of tubing members 303, 305 thereto.

With further reference to FIG. 1A, in conjunction with FIG. 3, filter assembly 100 preferably includes an attachment feature 160. Feature 160 is configured to facilitate holding filter assembly 100 in proximity to the user of assembly 100, and for carrying filter assembly 100 separate from a fluid reservoir, for example, via engagement with a strap-like member worn by the user, such as a belt or a shoulder strap like strap 33 of backpack 375, which is shown in FIG. 3. FIG. 1A illustrates attachment feature 160 extending from an outer surface of housing 120 and including an aperture 106 and a resilient clip arm 116; according to alternate embodiments, attachment feature 160 need only include one of aperture 106 and clip arm 116. FIG. 1A further illustrates a strap-like member 13 looped through aperture 106, according to one method of engagement, while FIG. 3 illustrates clip arm 116 engaged with shoulder strap 33, according to another method of engagement.

FIG. 4A is a plan view of a filter assembly 400, according to some alternate embodiments of the present invention. FIG. 4A shows filter assembly 400 via a cut-away section through a portable bottle 475 that contains a fluid reservoir 48, in which filter assembly 400 is immersed. Per the dashed lines of FIG. 4A, it may be appreciated that, like filter assembly 100, a housing 420 of assembly 400 contains filter element 10 and space 127, as previously described, and includes internal fitting 121, outlet port 122 and external fitting 123, also as previously described. In contrast to filter assembly 100, an inlet port 429 of filter assembly 400 is not surrounded by an external fitting, but is formed merely by apertures that extend through a sidewall of housing 420, for example, being similar to apertures 290 shown in FIG. 2.

According to the illustrated embodiment, a tubular member 403 is coupled to external fitting 123 and extends therefrom, through a lid 43 of bottle 475. A lumen of tubular member 403 is in fluid communication with outlet port 122 so that a suction force can be applied through tubular member 403 in order to draw fluid, through inlet port 429, from reservoir 48 into space 127, per arrow I, and then through filter element 10, and out through outlet port 122, per arrow O. Housing 420, like housing 120, is non-deformable under the normal operating pressures of assembly 400, and is preferably formed by a relatively rigid and inexpensive plastic material, such as ABS and/or polypropylene. FIG. 4A shows a lower portion 420B of housing 420 suspended above a bottom of bottle 475 by the coupling of external fitting 123 with tubular member 403. However, according to some alternate embodiments, lower portion 420B of housing 420 includes a feature, for example, like a plurality of foot-like protrusions 419 shown in FIG. 4B, to support assembly 400 against the bottom of bottle 475, while providing clearance for the passage of fluid between the bottom of bottle 475 and inlet port 429. Plurality of protrusions 419 preferably extend about a perimeter of inlet port 429, being spaced apart from one another.

In the foregoing detailed description, the invention has been described with reference to specific embodiments. However, it may be appreciated that various modifications and changes can be made without departing from the scope of the invention as set forth in the appended claims.

1. A portable filter assembly comprising:
a filter element including a filtering media core, a porous ceramic sidewall that surrounds the core and forms an outer surface of the filter element, and an end cap being coupled to a first end of the ceramic sidewall and having a channel extending therethrough in fluid communication with the filtering media core; and
a housing forming a space that surrounds the filter element, the housing containing the filter element and the space, and being non-deformable under normal operating pressures of the filter assembly; and
the housing comprising:
an internal fitting coupled to the end cap of the filter element;
an outlet port in fluid communication with the channel of the end cap;
an external fitting surrounding the outlet port and being configured for coupling with a suction source outside of the housing; and
an inlet port in fluid communication with the space that surrounds the filter element to allow a flow of fluid into the housing from outside of the housing, the space being essentially empty before the fluid flows into the housing, and the inlet port being located in proximity to a second end of the ceramic sidewall of the filter element, the second end being opposite the first end of the ceramic sidewall.

2. The assembly of claim 1, wherein the space comprises an annular section formed by a gap between the outer surface of the filter element and an inner surface of the housing, the gap being no greater than approximately 0.2 inch and extending over a length of the filter element, form the first end to the second end thereof, the length being between approximately 2.5 inches and approximately 3 inches.

3. The assembly of claim 1, wherein the external fitting includes a tapered section.

4. The assembly of claim 1, wherein the housing further comprises another external fitting surrounding the inlet port and being configured for coupling to a tubular member.

5. The assembly of claim 4, wherein the inlet port comprises a plurality of apertures formed through a sidewall of the housing.

6. The assembly of claim 1, wherein the inlet port comprises a plurality of apertures formed through a sidewall of the housing.

7. The assembly of claim 1, further comprising an attachment feature extending from an outer surface of the housing, the attachment feature being configured to engage with a strap-like member for holding the assembly in proximity to a user of the assembly.

8. The assembly of claim 7, wherein the attachment feature comprises a resilient clip arm.

9. The assembly of claim 1, wherein:
the housing is formed by at least a first part and a second part;
the first and second parts are reversibly attached to one another so that the parts can be separated from one another and then re-attached to one another;
and the first and second parts are configured so that, when the parts are separated, access to the filter element is provided, the end cap of the filter element can be un-coupled from the internal fitting and removed from the housing, and an end cap of a new filter element can be coupled to the internal fitting.

10. The assembly of claim 9, wherein:
the first part of the housing encompasses the internal fitting, the outlet port and the external fitting; and
the second part of the housing encompasses the outlet port.

11. The assembly of claim 1, wherein the housing further includes a feature to support a portion of the housing that is in proximity to the inlet port against a bottom of a fluid reservoir while providing clearance between the bottom and the inlet port.

12. The assembly of claim 11, wherein the feature comprises a plurality of foot-like protrusions that extend about a perimeter of the inlet port and are spaced apart from one another.

13. A portable filter assembly comprising:
a filter element including a filtering media core, a porous ceramic sidewall that surrounds the core and forms an outer surface of the filter element, and an end cap being coupled to a first end of the ceramic sidewall and having a channel extending therethrough in fluid communication with the filtering media core; and
a housing forming a space that surrounds the filter element, the housing containing the filter element and the space, and being non-deformable under normal operating pressures of the filter assembly, and the space comprising an annular section formed by a gap between the outer surface of the filter element and an inner surface of the housing, the gap being no greater than approximately 0.2 inch and extending over a length of the filter element, from the first end to a second end thereof, the length being between approximately 2.5 inches and approximately 3 inches; and
the housing comprising:
an internal fitting coupled to the end cap of the filter element;
an outlet port in fluid communication with the channel of the end cap;
an external fitting surrounding the outlet port and being configured for coupling with a suction source outside of the housing; and
an inlet port in fluid communication with the space that surrounds the filter element to allow a flow of fluid into the housing from outside of the housing, the space being essentially empty before the fluid flows into the housing.

14. The assembly of claim 13, wherein the external fitting includes a tapered section.

15. The assembly of claim 13, wherein the housing further comprises another external fitting surrounding the inlet port and being configured for coupling to a tubular member.

16. The assembly of claim 15, wherein the inlet port comprises a plurality of apertures formed through a sidewall of the housing.

17. The assembly of claim 13, wherein the inlet port comprises a plurality of apertures formed through a sidewall of the housing.

18. The assembly of claim 13, further comprising an attachment feature extending from an outer surface of the housing, the attachment feature being configured to engage with a strap-like member for holding the assembly in proximity to a user of the assembly.

19. The assembly of claim 18, wherein the attachment feature comprises a resilient clip arm.

20. The assembly of claim 13, wherein:
the housing is formed by at least a first part and a second part;
the first and second parts are reversibly attached to one another so that the parts can be separated from one another and then re-attached to one another;
and the first and second parts are configured so that, when the parts are separated, access to the filter element is provided, the end cap of the filter element can be un-coupled from the internal fitting and removed from the housing, and an end cap of a new filter element can be coupled to the internal fitting.

21. The assembly of claim 20, wherein:
the first part of the housing encompasses the internal fitting, the outlet port and the external fitting; and
the second part of the housing encompasses the outlet port.

22. A method of providing filtered hydration from a portable fluid reservoir, the method comprising:
coupling a first tubing member to a first external fitting of a portable housing, the first external fitting surrounding an inlet port of the housing, the first tubing member extending from the portable fluid reservoir and having a lumen, the lumen being in fluid communication with the reservoir, the housing containing a filter element and forming a space that surrounds the filter element, and the inlet port of the housing being in fluid communication with the space that surrounds the filter element, such that, when the first tubing member is coupled to the first external fitting, the lumen of the first tubing member is also in fluid communication with the space;
engaging a strap-like member with an attachment feature that extends from an outer surface of the housing, to hold the housing in proximity with a recipient of the filtered hydration; and
applying a suction force to a second external fitting of the housing, the second external fitting surrounding an outlet port of the housing, and the outlet port being in fluid communication with a core of the filter element, such that the suction force draws fluid from the reservoir, into the space, through the filter element, and out the outlet port.

23. The method of claim 22, further comprising:
coupling a second tubing member to the second external fitting of the housing, prior to applying the suction force, such that a lumen of the second tubing member is in fluid communication with the outlet port; and
wherein the suction force is applied through the lumen of the second tubing member and the fluid is drawn into the lumen of the second tubing member.

24. The method of claim 22, further comprising:
separating a first part of the housing from a second part of the housing;
removing the filter element from the first part of the housing, after separating the first part from the second part;
replacing the removed filter element with a new filter element in the first part of the housing; and
re-attaching the first and second parts of the housing to one another, after replacing the removed filter element.
